(19) United States
(12) Patent Application Publication
(10) Pub. No.: US 2024/0200560 A1
(43) Pub. Date: Jun. 20, 2024

(54) METHOD FOR IDENTIFICATION OF IMPELLER WEAR AND EXCESSIVE WEAR-RING CLEARANCE IN CENTRIFUGAL PUMPS

(71) Applicant: Schneider Toshiba Inverter Europe SAS, Pacy sur Eure (FR)

(72) Inventor: Kamal Ejjabraoui, Gravigny (FR)

(73) Assignee: Schneider Toshiba Inverter Europe SAS, Pacy sur Eure (FR)

(21) Appl. No.: 18/533,797

(22) Filed: Dec. 8, 2023

(30) Foreign Application Priority Data
Dec. 14, 2022 (EP) 22306872.7

(51) Int. Cl. F04D 15/00; G01M 13/005

(52) U.S. Cl. CPC F04D 15/0088; G01M 13/005

(57) ABSTRACT

A method for determining mechanical degradation of parts of a centrifugal pump having a fluid inlet, an impeller, and a fluid outlet. The method includes calculating at least one of a wear-ring clearance effect and an impeller wear effect. The wear-ring clearance effect is calculated using measurements of an actual pump flow rate Qp and actual pump power Pwp, calculating an internal flow rate of the pump Qp_{Pwp}, calculating the mechanical power Pw_{Qp} that should be used if the pump worked as specified in a theoretical curve, and calculating a difference between a theoretical Head and an internal Head Hpₜₕ−Hp_{Pwp} to obtain the loss of Head due to the wear-ring clearance. The impeller wear effect is calculated by measuring an actual input pressure pᵢₙ, an actual output pressure pₒᵤₜ and an actual pump power Pwp, calculating a theoretical flow rate QpPwp corresponding to the measured mechanical power Pwp, calculating a theoretical Pump Head HpPwp, calculating the actual Pump Head Hp from the actual input pressure pᵢₙ, and the actual output pressure pₒᵤₜ and a pumped fluid density, and calculating a difference between the theoretical pump head and the actual pump Head HpPwp−Hp to obtain the loss of head due to the impeller wear.

### FIELD OF THE INVENTION

The present disclosure concerns pumps and more precisely centrifugal pumps and their maintenance.

### BACKGROUND

In most of the applications, pumps are used in different conditions extremely unfavorable for the health of the pump. In fact, the typology of the transported fluid such as abrasiveness, corrosiveness, the operation of the pump system in a not preferred work area of the pump and also cavitation accelerates the degradation of the pump mechanical parts such as wheel, mechanical seal, wear-ring clearance and leads to a decrease of the pump performances and of the process using such pump.

### SUMMARY OF THE INVENTION

The objective of the present disclosure is to propose a method providing a solution to identify the impact of excessive wear-ring clearance, excessive clearance between the tips of the blades of the impeller and the pump body, caused by wear of the blade tips and the impact of the impeller wear and on the whole performance of the centrifugal pump. The method considers the initial status of the pump from the datasheet of the pump as an initial characteristic and associates the evolution of the pump curves to an evolution of the internal mechanical part of the pump. The method uses specific calculations which define the impact of the impeller wear and the impact of an excessive wear-ring clearance on the whole pump performance.

More precisely the present disclosure proposes a method for determining mechanical degradation of parts of a centrifugal pump having a fluid inlet, an impeller, and a fluid outlet, said method comprising:
calculating at least one of a wear-ring clearance effect and an impeller wear effect.
Calculating said wear-ring clearance effect is done through:
   measuring an actual pump flow rate Qp and actual pump power Pwp,
   calculating an internal flow rate of the pump Qp_{Pwp} through projecting said actual pump power Pwp on a theoretical Pump Mechanical power versus Pump Flow rate curve at iso mechanical power,
   calculating the mechanical power Pw_{Qp} that should be used if the pump worked as specified in the theoretical curve through projecting said actual pump flow rate on said theoretical Pump Mechanical Power versus Pump Flow rate curve at iso flow rate,
   applying the measured flow rate Qp on a theoretical Pump Head versus Pump Flow rate curve to obtain a theoretical Head Hpₜₕ,
   applying the internal flow rate of the pump Qp_{Pwp} on said theoretical Pump Head versus Pump Flow rate curve to obtain an internal Head Hp_{Pwp},
   calculating a difference between said theoretical Head and said internal Head Hpₜₕ
   Hp_{Pwp} to obtain the loss of Head due to the wear-ring clearance;
Calculating said impeller wear effect is done through:
   measuring an actual input pressure pᵢₙ, an actual output pressure pₒᵤₜ and an actual pump power Pwp,
   calculating a theoretical flow rate Qp_{Pwp} corresponding to the measured mechanical power Pwp on a theoretical pump characteristic Pump Power versus Pump Flow rate curve,
   projecting such theoretical flow rate Qp_{Pwp} on a theoretical Pump Head versus Pump Flow rate curve 15 at iso-pump flow rate ΔQ=0 to obtain a theoretical Pump Head Hp_{Pwp},
   calculating an actual Pump Head Hp from the actual input pressure pᵢₙ, and the actual output pressure pₒᵤₜ and a pumped fluid density,
   calculating a difference between said theoretical pump head and said actual pump Head Hp_{Pwp}−Hp to obtain the loss of head due to the impeller wear.

The method may comprise calculating a flow rate inside the pump

$${Q}_{{p}_{pump}} = Q {p}_{Pwp} = Q p + Δ Q ,$$

where ΔQ is the additional flow rate due to the increasing of the wear-ring clearance compared to the initial status of the pump that is provided by the theoretical Pump Head versus Flow rate curve, and considering that at the pump head Hp_{Pwp} corresponding to the measured power and at iso-Pump Head H=Hₜₕ=Hp_{Pwp} the Hydraulic efficiency being equal to 1, setting a hydraulic efficiency at:

$${η}_{HY} = \frac{H}{{H}_{th}} = 1 .$$

The method may then comprise:
calculating a mechanical efficiency:

$${η}_{m} = \frac{{P}_{I}}{{P}_{s}} = \frac{ρ \cdot g \cdot {Hp}_{Pwp} ( {Q}_{p} + Δ Q )}{{Pw}_{p}}$$

calculating a volumetric efficiency:

$${η}_{v} = \frac{{Q}_{p}}{( {Q}_{p} + Δ Q )}$$

and calculating the efficiency of the pump with pump wear-ring clearance impact

$${η}_{wearRing} = {η}_{m} \times {η}_{HY} \times {η}_{v} = \frac{ρ . g . {Hp}_{Pwp} \cdot {Q}_{p}}{{Pw}_{p}}$$

The method may also comprise calculating a theoretical efficiency:

$${η}_{theoretical} = \frac{ρ . g . {H}_{{P}_{th}} \cdot Qp}{{Pw}_{Q p}}$$

where Hpₜₕ=Hp_{Qp} the theoretical head calculated with the theoretical pump curve (Head vs. Flow rate) using the measured flow rate and Pw_{Qp} is the calculated power with the theoretical curve Power vs. Flow rate within the measured flow rate
and calculating an impact of the Excessive wear-ring clearance on the overall pump as:

$${η}_{WearRingImpact} = \frac{{η}_{wearRing} - {η}_{theoretical}}{{η}_{theoretical}}$$

The method may also comprise calculating an impeller wear impact at iso-pump flow rate ΔQ=0 with
calculating a mechanical efficiency:

$${η}_{m} = \frac{{P}_{1}}{{P}_{s}} = \frac{ρ . g . {Hp}_{th} ( Qp + Δ Q )}{{Pw}_{Qp}} = \frac{ρ . g . {Hp}_{th} \cdot Qp}{{Pw}_{Qp}}$$

and
calculating the efficiency of the pump with impeller wear impact

$${η}_{impellerWear} = {η}_{m} \times {η}_{HY} \times {η}_{v} = \frac{ρ . g . ( {Hp}_{th} - ( {Hp}_{pwp} - Hp ) ) \cdot Qp}{{Pw}_{Qp}}$$

where

$${η}_{HY} = \frac{{Hp}_{th} - ( {Hp}_{pwp} - Hp )}{{Hp}_{th}}$$

$$and$$

$${η}_{v} = 1$$

and Pw_{Qp} is the power calculating with the projection of the measured flow rate Qp on the theoretical Pump Power versus Pump Flow rate.

The method may also comprise calculating the impact of the impeller wear on the overall pump wear as:

$${η}_{ImpellerWearImpact} = \frac{{η}_{impellerWear} - {η}_{theoretical}}{{η}_{theoretical}}$$

$$where$$

$${η}_{theoretical} = \frac{ρ . g . {H}_{{P}_{th}} \cdot Qp}{{Pw}_{Q p}}$$

where the theoretical head Hpₜₕ is Hp_{Qp} calculated with the theoretical pump curve Head vs. Flow rate using the measured flow rate and Pw_{Qp} is the calculated power with the theoretical curve Power vs. Flow rate within the measured flow rate.

In a preferred embodiment, the method is repeated from time to time to obtain a plurality of measurements of the global efficiency of the pump.

The method may then comprise identifying with said program an evolution of a pump wear-ring clearance evolution through calculating said wear-ring clearance effect through measuring the initial power and flow rate of the pump at a time to, calculating the initial Head of the pump Hp_{Pwp}, calculating the initial loss of Head (Hpₜₕ−Hp_{Pwp})ₜ₀, measuring from time to time tₙ=tₙ₋₁+Δt with the pump in use the power and flow rate of the pump and calculating the head and loss of Head due to the wear-ring clearance, comparing the obtained wear-ring clearance effect (Hpₜₕ−Hp_{Pwp})ₜₙ at a time tₙ with the initial Head loss at t0 to obtain a wear-ring clearance evolution of the pump.

Such method may comprise a program designed to detect an evolution of a pump impeller wear evolution through calculating said impeller wear effect through measuring an initial input pressure pinto, an actual output pressure pₒᵤₜ₀ and an initial pump power Pwpₜ₀ of the pump at a time to, calculating the initial Head of the pump Hp_{Pwp} at iso-pump flow rate ΔQ=0, calculating the initial loss of Head (Hp_{Pwp}−Hp)ₜ₀, measuring from time to time tₙ=tₙ₋₁+Δt with the pump in use the input pressure pᵢₙₜₙ, output pressure pₒᵤₜₜₙ and pump power Pwpₜₙ of the pump and calculating the head and loss of Head due to the impeller wear at iso-pump flow rate ΔQ=0, comparing the obtained impeller wear (Hp_{Pwp}−Hp)ₜₙ with the initial Head loss to obtain a impeller wear evolution of the pump.

In an advantageous embodiment, the measurements of the method are done in real time during operation of the pump.

The method may comprise comparing of an actual flow rate with at least one customer defined flow rate lower limit and providing a warning signal in case of detection of a flow rate lower than said lower limit.

The method may also comprise a calculation of the impact of the degradation on the efficiency of said impeller and provision of ageing data comprising flow rate reduction and/or head reduction.

The method may also comprise a calculation of the impact of such degradation on the energy consumption of the pump.

The method may also comprise creating warning signals upon detection of defined wear-ring clearance and/or impeller wear for providing data for predictive maintenance.

The method may comprise an initialization step where said theoretical Pump mechanical Power versus Flow rate curve, said theoretical Head versus Flow rate curve from the pump manufacturer as initial theoretical pump data are entered in a calculation program executing the method.

In another aspect, it is proposed a computer software comprising instructions to implement at least a part of a method as defined here when the software is executed by a processor. In another aspect, it is proposed a computer-readable non-transient recording medium on which a software is registered to implement the method as defined here when the software is executed by a processor.

### BRIEF DESCRIPTION OF THE DRAWINGS

A detailed description of exemplary embodiments of the invention will be discussed hereunder in reference to the attached drawings where:

FIG. 1: shows a side cut view of a centrifugal pump;

FIG. 2A: shows a Pump Mechanical Power versus Pump Flow Rate curve for a new and a damaged pump;

FIG. 2B: shows a Pump Head versus Pump flow rate curve for a new and a damaged pump;

FIG. 3: shows degradation curves of a pump during part of its life;

FIG. 4: shows a simplified flowchart of a first measurement of the disclosure;

FIG. 5: shows a simplified flowchart of a second measurement of the disclosure;

FIGS. 6A and 6B: shows a simplified flowcharts of other calculations of the disclosure;

FIG. 7: shows a simplified flowchart of a first method of measuring evolution of a pump according to the disclosure;

FIG. 8: shows a simplified flowchart of a second method of measuring evolution of a pump according to the disclosure;

### DETAILED DESCRIPTION OF EMBODIMENTS OF THE INVENTION

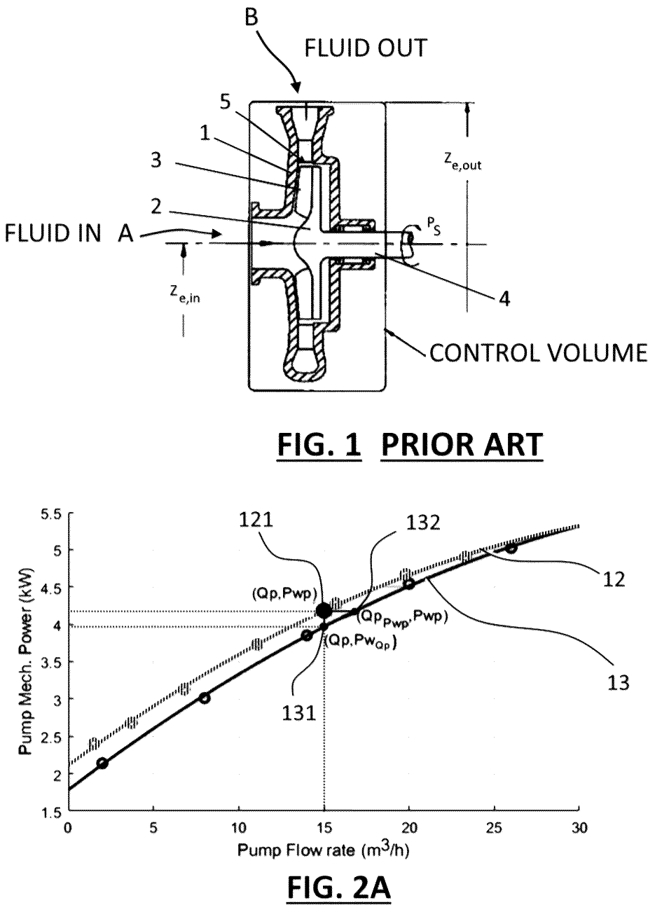

The present invention concerns a method for identifying the impact of an impeller wear and excessive wear-ring clearance on the whole performance of a centrifugal pump such as shown in FIG. 1 having a body 1, an impeller 2 with impeller blades 3 and impeller axis 4.

Centrifugal pumps are working in different hydraulic applications, from clean water to wastewater applications. It transports different kinds of fluid with different properties and densities. During their operation, the different mechanical parts (impeller, blades, wear-ring, diffuser . . . ) that compose a centrifugal pump suffer, and they can wear differently depending on the causes: cavitation, corrosion, abrasion, abnormal usage . . . ; The degradation of those parts generates internal losses and decreases the performance of such pumps. The losses can be quantified in terms of flow rate and losses in terms of pump total dynamic head capacity.

Three major losses inside a centrifugal pump are considered:
Friction losses
Shock losses
Leakage losses

The leakage losses are associated with an excessive wear-ring clearance that is the wear of the blades tips and wear-ring which causes an excessive clearance 5 inside the carter of the pump. Such excessive clearance increases the flow rate recirculating between the rotating and stationary parts of the pump stage. Because of such clearance, the pump is rejecting a flow rate quantity lower than what has been stirred inside the pump. The flow rate inside the pump is higher than what can be measured in the discharge line of the pump.

Friction losses and shock losses are associated with the wear of the impeller and diffuser because they mainly participate in decreasing of the pump head at a same pumped flow due to losses by friction on the walls of the blades 3 and by shock due to the modification of angles of attack of worn blades.

Friction loss is prominent at high flow rates. In contrast, leakage loss is more present at relatively low flow rates. Shock loss takes place when the liquid flow rate differs from the designed flow rate.

The objective of the present disclosure is to provide a method to identify the impact of both the impeller wear and the excessive wear-ring clearance on the overall performance of a centrifugal pump having a fluid inlet A, an impeller 2 and a fluid outlet B.

The first law of thermodynamics provides

$${P}_{s} = \dot{m} [ {( h + \frac{{V}^{2}}{2} + {gZ}_{e} )}_{out} - {( h + \frac{{V}^{2}}{2} + {gZ}_{e} )}_{in} ]$$

$$with$$

$$h = u + \frac{p}{ρ}$$

in which:
Ps is the motor shaft power
\dot{m} is the mass flow rate (kg/s)
u is the internal energy (kcal/kg multiplied by J·m²/s²)
p is the static pressure (Pa=N/m²)
ρ is the fluid mass density
V is the absolute velocity of fluid (m/s)
g is the acceleration due to gravity (9.80665 m/s²)
Ze is the elevation height at the point of interest (m)

The shaft power is commonly expressed in terms of “Head” and mass flow rate as in the following equation:

$$\frac{{P}_{s}}{\dot{m}} = g Δ H + Δ u$$

$$H = \frac{p}{ρ g} + \frac{{V}^{2}}{2 g} + {Z}_{e}$$

where ΔH is the Head across the pump (m)

The change in H is called the “Head” ΔH of the pump; and because H includes the velocity head V²/2 g and the elevation head Ze at the point of interest, ΔH is often called the “total dynamic head”. ΔH is often abbreviated to simply “H” and is the increase in height of a column of liquid that the pump would create if the static pressure head p/ρg and the velocity head V²/2 g were converted without loss into elevation head Ze their respective locations at the inlet A to and outlet B from the control volume.

Not all the mechanical input energy per unit mass ends up as useful pump output energy per unit mass gΔH. This is expressed by:

$$\frac{{P}_{s}}{\dot{m}} > g Δ H$$

$$or$$

$$η < 1$$

The overall pump efficiency η is expressed by the following equation:

$$η = \frac{g Δ H \dot{m}}{{P}_{s}}$$

The mass flow rate m can be expressed by:

$$\dot{m} = ρ Q$$

### Where:

Q is the flow rate (m³/s).

Then:

$$η = \frac{{P}_{I}}{{P}_{s}} \times \frac{g Δ H ( \dot{m} + {\dot{m}}_{Le} )}{{P}_{I}} \times \frac{\dot{m}}{( \dot{m} + {\dot{m}}_{L} )}$$

### Where:

$${P}_{1} = g Δ {H}_{th} ( \dot{m} + {\dot{m}}_{Le} )$$

In which Hₜₕ is the theoretical Head without losses inside the pump,
and Le are the leakages which provides:

$$η = \frac{{P}_{I}}{{P}_{s}} \times \frac{Δ H}{Δ {H}_{th}} \times \frac{Q}{( Q + {Q}_{L} )} = {η}_{m} \times {η}_{HY} \times {η}_{v}$$

The mechanical efficiency is defined as:

$${η}_{m} = \frac{{P}_{I}}{{P}_{s}} = \frac{{P}_{s} - {P}_{D}}{{P}_{s}}$$

The hydraulic efficiency is defined as:

$${η}_{HY} = \frac{Δ H}{Δ {H}_{th}} = \frac{Δ {H}_{i} - \sum {H}_{L}}{Δ {H}_{th}}$$

where the initial head Hi is the theoretical head Hₜₕ and where H_{L} corresponds to losses,

The volumetric efficiency is defined as:

$${η}_{v} = \frac{Q}{( Q + {Q}_{Le} )}$$

The theoretical head is defined by the following equation:

$${H}_{th} = \frac{{( 2 π {R}_{2} )}^{2}}{g} \times {N}^{2} + \frac{2 π {R}_{2}}{g {S}_{2}} \times \frac{cos ( {β}_{2} )}{\vert sin ( {β}_{2} ) \vert} \times N \times {q}_{v}$$

An equation that defines wear of a pump is:

$${H}_{r} = {H}_{th} - {H}_{friction} - {H}_{Shock} - {H}_{L e akage} - {H}_{recirculation} - {H}_{diffuser} - {H}_{disk}$$

Pump manufacturers provide pump curve datasheets which are already considering initial losses of a pump due to friction, shock, and leakage inside the pump as manufactured. As known in the art, the pump curves are different from the Euler theoretical head curve. In the present disclosure, the initial status of the pump as in the datasheet becomes the theoretical characteristic of the pump on which calculations are based. The evolution of the pump curve starting from the datasheet corresponds to an evolution of the internal mechanical parts of the pump.

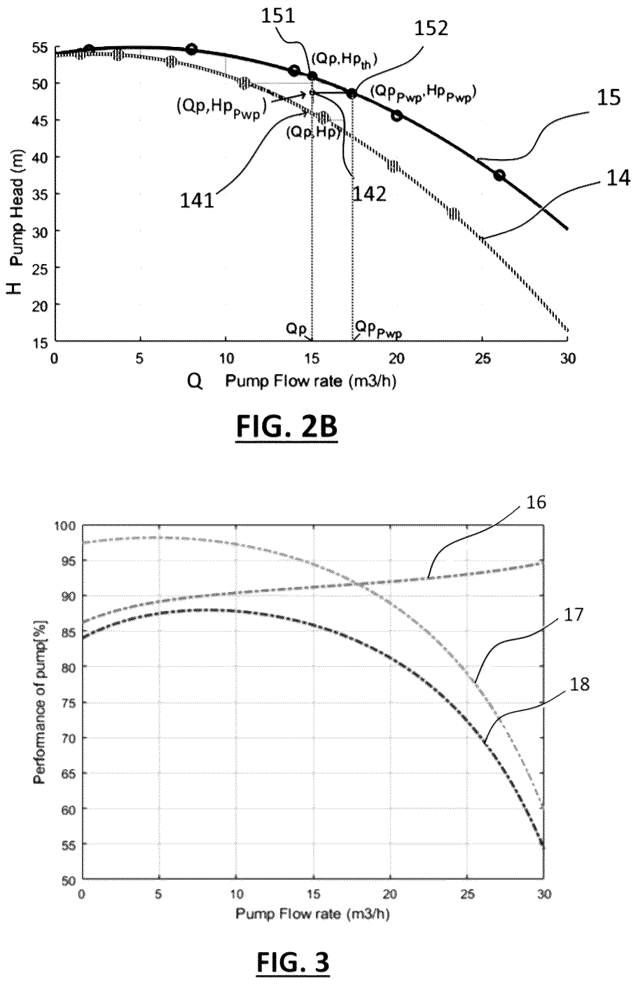

The present disclosure provides an identification of the impact of the impeller wear and excessive wear-ring clearance on the whole pump performance. A purpose of the present disclosure is to detect the evolution of both mechanical parts inside the pump and how they impact the performance and energy consumption of the pump. The proposed method is based on a model of efficiency and a method to separate impeller wear and excessive wear-ring clearance based on Mechanical Power versus Flow Rate curves such as in FIG. 2A which shows an actual pump curve 12 in dotted line and a theoretical or manufacturer curve 13 in solid line and based on Pump Head versus Flow Rate curves such as in FIG. 2B which shows an actual pump curve 14 in dotted lines and a theoretical or manufacturer curve 15 in solid line.

Considering an operating point measured on an example of installation in use for pumping water in which a Pump flow rate is for example 15 m3/h, a Pump Head: 46 m, a Pump Mechanical power: 4.18 kW. A wear-ring clearance impact can be seen on the characteristic “Pump mechanical power vs. Flow rate” of FIG. 2A where, at the operating point 121 having a pump flow rate Qp, and a measured power Pwp, such power Pwp is higher than the theoretical power Pw_{Qp} on the theoretical Mechanical Power versus Pump Flow rate curve 13 corresponding to Qp at point 131. In such curve, Qp_{Pwp} is the projection of the measured power on the theoretical Mechanical Power versus Pump Flow rate curve 13 at point 132 allowing calculate the flow rate that the pump sees internally including the internal recirculation due to wear-ring clearance. Pw_{Qp} is the projection of the measured flow rate 121 on the theoretical Mechanical Power versus Pump Flow rate curve 13 and corresponds to the mechanical power that should be given if the pump behaves as given by the pump manufacturer. It should be noted that the actual pump curve 12 is shown for a better understanding of the phenomenon but only the current working point Qp, Pwp is needed for the calculation. With a projection of theses operating points on the characteristics Pump Head versus Pump flow rate in FIG. 2B where the theoretical curve 15 is the solid line and the actual pump curve 14 is the dotted line for reference, it can be observed that the impact of the internal re-circulation in the pump implies a drop of the pump head Hp_{Pwp} at point 142 from the theoretical pump head Hpₜₕ that should be obtained at the measured flow rate Qp at point 151. This provides the impact of the wear-ring clearance on the pump head because the pump doesn't see the flow rate measured externally but the flow rate inside the pump which is higher than measured:

$${Q}_{{p}_{pump}} = {Q}_{{p}_{Meas}} + Δ Q$$

$$Where :$$

$${Q}_{{p}_{pump}} = Q {P}_{Pwp}$$

$${Q}_{{p}_{Meas}} = {Q}_{p}$$

ΔQ is the additional flow rate due to the increasing of the wear-ring clearance compared to initial status of the pump that is provided by the Manufacturer.

To identify the impact of the wear-ring clearance on the overall efficiency of the pump, it can be considered that for the same pump head Hp_{Pwp} corresponding to the measured power, there is, according to FIG. 2B, a point at (Qp, HP_{Pwp}) and a point at (Qp_{Pwp}, Hp_{Pwp}). Then, because at Iso-Pump Head: ΣH_{L}=0, the Head H=Hₜₕ=Hp_{Pwp}. In consequence, the measures necessary to determine the wear-ring clearance impact in such case are flow rate and mechanical power.

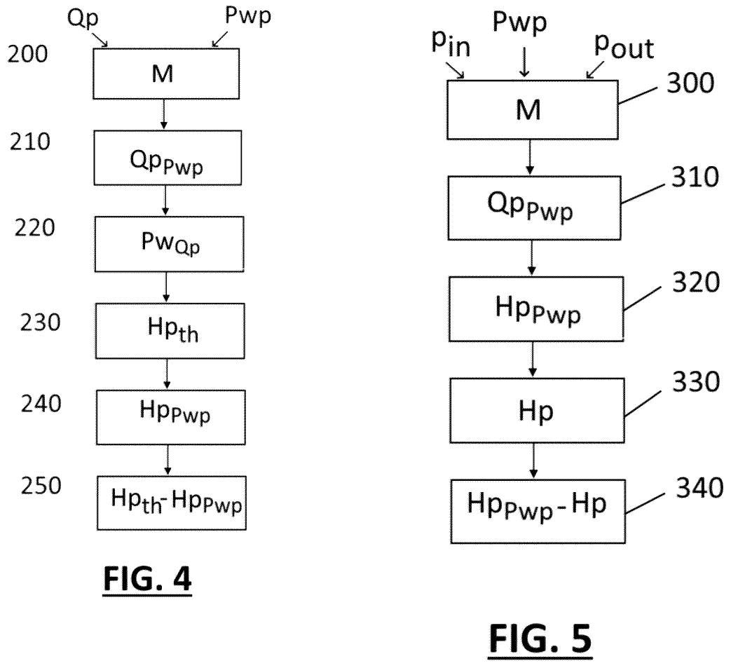

The method to determine the wear-ring clearance effect shown on the flowchart of FIG. 4 uses:
measuring 200 an actual pump flow rate Qp and actual pump power Pwp 121,
calculating 210 an internal flow rate of the pump Qp_{Pwp} 132 through projecting said actual pump power Pwp on a theoretical Pump Mechanical power versus Pump Flow rate curve (13) at iso mechanical power,
calculating 220 the mechanical power Pw_{Qp} 131 that should be present if the pump works as specified in the theoretical curve through projecting said actual pump flow rate on said theoretical Pump Mechanical Power versus Pump Flow rate curve 13 at iso flow rate,
applying 230 the measured flow rate Qp on a theoretical Pump Head versus Pump Flow rate curve 15 to obtain a theoretical Head Hpₜₕ 151,
applying 240 the internal flow rate of the pump Qp_{Pwp} on said theoretical Pump Head versus Pump Flow rate curve 15 to obtain an internal Head Hp_{Pwp} 152,
calculating 250 a difference between said theoretical Head and said internal Head Hpₜₕ−Hp_{Pwp} to obtain the loss of Head due to the wear-ring clearance.

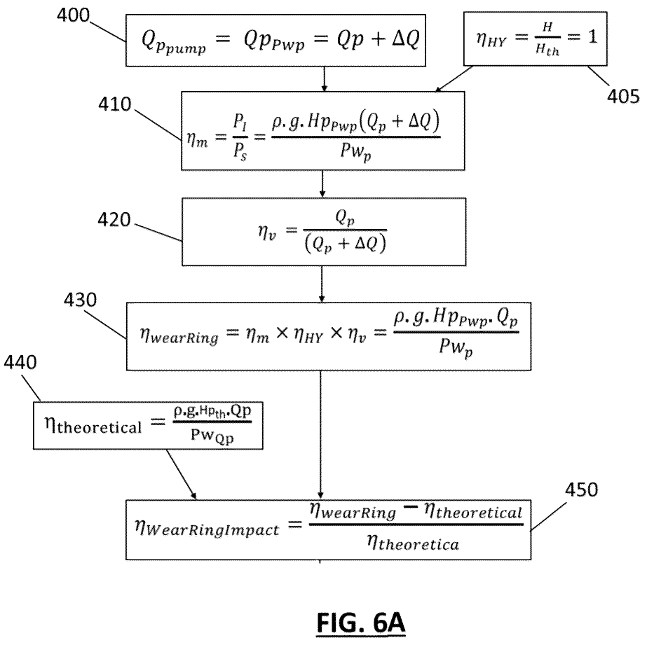

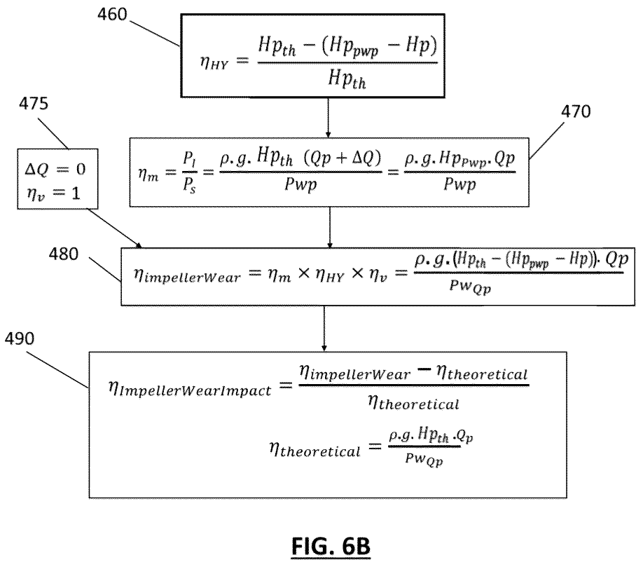

In FIG. 6A is a method that comprises calculating 400 a flow rate inside the pump

$${Q}_{{p}_{pump}} = Q {p}_{Pwp} = Q p + Δ Q ,$$

Where ΔQ is the additional flow rate due to the increasing of the wear-ring clearance compared to the initial status of the pump that is provided by the theoretical Pump Head versus Flow rate curve 15. Considering that at the pump head Hp_{Pwp} corresponding to the measured power and at iso-Pump Head H=Hₜₕ=Hp_{Pwp} the Hydraulic efficiency being equal to 1, the method comprises setting 405 a hydraulic efficiency at:

$${η}_{HY} = \frac{H}{{H}_{th}} = 1 ,$$

And comprises calculating 410 a mechanical efficiency.

$${η}_{m} = \frac{{P}_{I}}{{P}_{s}} = \frac{ρ . g . {Hp}_{Pwp} ( {Q}_{p} + Δ Q )}{{Pw}_{p}}$$

Still considering the hydraulic efficiency:

$${η}_{HY} = \frac{H}{{H}_{th}} = 1$$

at step 405

and the mechanical efficiency.

$${η}_{m} = \frac{{P}_{I}}{{P}_{s}} = \frac{ρ . g . {Hp}_{Pwp} ( {Q}_{p} + Δ Q )}{{Pw}_{p}}$$

at step 410 with the volumetric efficiency transformed in:

$${η}_{v} = \frac{{Q}_{p}}{( {Q}_{p} + Δ Q )}$$

at step 420 allows to define the efficiency due only to pump wear-ring clearance impact:

$${η}_{wearRing} = {η}_{m} \times {η}_{HY} \times {η}_{v} = \frac{ρ . g . {Hp}_{Pwp} \cdot {Q}_{p}}{{Pw}_{p}}$$

The impact of the Excessive wear-ring clearance on the overall pump wear is then calculated at 450 as:

$${η}_{WearRingImpact} = \frac{{η}_{wearRing} - {η}_{theoretical}}{{η}_{theoretical}}$$

### Where

$${η}_{theoretical} = \frac{ρ . g . {Hp}_{th} \cdot {Q}_{p}}{P {w}_{Qp}}$$

is introduced at 440.

This permits to remove the part of pump head from the theoretical pump head at a flow rate value Qp that has been changed due to the increasing of wear-ring clearance.

Identification of the impact of impeller wear on the characteristic is possible with measurements of pressure upstream and downstream of the pump to get the pump head Hp and mechanical power measurement since such impact is only dependent on the head losses from frictions and shocks on the blades.

The method for calculating said impeller wear effect is shown in FIG. 5 and done through:
measuring 300 an actual input pressure pᵢₙ, an actual output pressure pₒᵤₜ and an actual pump power Pwp,
calculating 310 a theoretical flow rate Qp_{Pwp} corresponding to the measured mechanical power Pwp 132 on a theoretical pump characteristic Pump Power versus Pump Flow rate curve 13,

Projecting 320 such theoretical flow rate Qp_{Pwp} 152 on a theoretical Pump Head versus Pump Flow rate curve 15 at iso-pump flow rate ΔQ=0 to obtain a theoretical Pump Head Hp_{Pwp},
calculating 330 the actual Pump Head Hp from the actual input pressure pᵢₙ, and the actual output pressure pₒᵤₜ and a pumped fluid density as known in the art,
calculating 340 the loss of head due to the impeller wear as Hp_{Pwp}−Hp.

At Iso-Pump Flow axis, the volumetric efficiency may be expressed as shown by the following formula:

$${η}_{v} = 1$$

because at iso-flow, there is no consideration of ΔQ, the volumetric efficiency is equal to 1.

The measured mechanical power Pwp is projected on the theoretical Mechanical Pump Power versus Pump Flow rate curve 13 to obtain a theoretical pump flow rate Qp_{Pwp} corresponding to such mechanical power Pwp. Then, the theoretical Pump Flow rate is used to obtain a theoretical Head Hp_{Pwp} which after calculation of the current Head Hp with the input and output pressures allows to express the hydraulic efficiency by:

$${η}_{HY} = \frac{{Hp}_{th} - ( {Hp}_{pwp} - Hp )}{{Hp}_{th}}$$

The mechanical efficiency at iso-flow ΔQ=0 allowing to calculate in 470:

$${η}_{m} = \frac{{P}_{I}}{{P}_{S}} = \frac{ρ \cdot g \cdot {Hp}_{th} ( {Q}_{p} + Δ Q )}{{Pw}_{Qp}} = \frac{ρ \cdot g \cdot {Hp}_{th} \cdot {Q}_{p}}{{Pw}_{Qp}}$$

Which allows to define in 480 the loss of efficiency due only to pump wear-ring clearance:

$${η}_{impellerWear} = {η}_{m} \times {η}_{HY} \times {η}_{v} = \frac{ρ \cdot g \cdot ( {Hp}_{th} - ( {Hp}_{pwp} - Hp ) ) \cdot {Q}_{p}}{{Pw}_{Qp}}$$

considering in 475 that ηᵥ=1, the impact of the impeller wear on the overall pump wear is then given by:

$${η}_{ImpellerWearImpact} = \frac{{η}_{impellerWear} - {η}_{theoretical}}{{η}_{theoretical}} \\ Where {η}_{theoretical} = \frac{ρ \cdot g \cdot {Hp}_{th} \cdot {Q}_{p}}{{Pw}_{Qp}} in step 490.$$

All these calculated data may be displayed on a monitoring computer or memorized to provide tracking of the degradation of the pump in order to provide information as per the risk of failure in predictive maintenance programs.

This allows to identify a fault related to both impeller wear or/and excessive wear-ring clearance to a predefined threshold (based on the norm: Pump Detection Tolerances ISO9906).

The method of calculating the wear data may be repeated from time to time to obtain a plurality of measurements of the global efficiency of the pump during its working life.

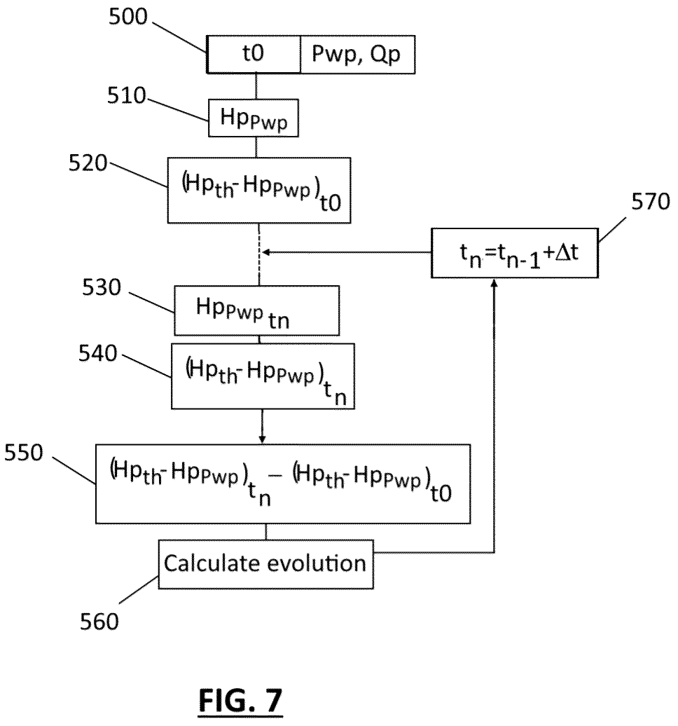

A program designed to detect an evolution of a pump wear-ring clearance evolution such as shown in FIG. 7 may calculate said wear-ring clearance effect through measuring the initial power and flow rate of the pump at a time to step 500, calculating 510 the initial Head of the pump Hp_{Pwp}, calculating 520 the initial loss of Head (Hpₜₕ−Hp_{Pwp})ₜ₀ as an initialization phase. Then the program may measure from time to time tₙ=tₙ₋₁+Δt 570, e.g. every day or week or at dedicated times within the life of the pump, with the pump in use the power and flow rate of the pump and calculate the head 530 and loss of Head 540 due to the wear-ring clearance, comparing 550 the obtained wear-ring clearance effect (Hpₜₕ−Hp_{Pwp})tₙ with the initial Head loss to obtain a wear-ring clearance evolution 560 of the pump.

Again, this can be done periodically, and the values displayed and/or memorized to draw wear curves of the pump.

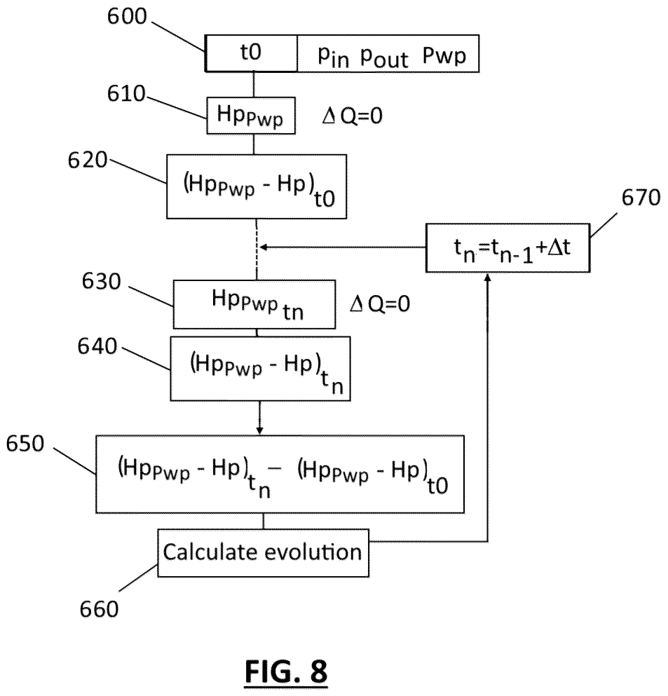

The program as depicted in FIG. 8 may also survey an evolution of a pump impeller wear evolution through calculating said impeller wear effect through measuring an initial input pressure pinto, an actual output pressure pₒᵤₜₜ₀ and an initial pump power Pwpₜ₀ of the pump at a time t0 600 as an initialization. Then during life of the pump similarly, the program may calculate 610 the initial Head of the pump Hp_{Pwp} at iso-pump flow rate ΔQ=0, calculate 620 the initial loss of Head (Hp_{Pwp}−Hp)ₜ₀, measuring from time to time tₙ=tₙ₋₁+Δt at 670 with a volumetric efficiency set to 1 in step 675 with the pump in use the input pressure pᵢₙₜₙ, output pressure pₒᵤₜₜₙ and pump power Pwpₜₙ of the pump and calculate the head 630 and loss of Head 640 due to the impeller wear at iso-pump flow rate ΔQ=0, compare 650 the obtained impeller wear (Hp_{Pwp}−Hp)tₙ with the initial Head loss to obtain a impeller wear evolution 660 of the pump.

The calculations of FIGS. 6A and 6B may also be done at each iteration of the two program parts shown in FIGS. 7 and 8 and discussed above embedding the programs of FIGS. 4 and 5, the measurements and calculation being preferably done in real time during operation of the pump.

It should be noted again that the actual curve Pump Mechanical Power versus Pump Flow rate 12 in FIG. 2A and the curve Pump Head versus Pump Flow rate 14 in FIG. 2B are not calculated and are shown for understanding the wear phenomena since only a working point with (Qp, Pwp) values is needed to obtain the wear-ring clearance effect and only a working point with (Hp, Pwp) values is needed to obtain the impeller wear effect at a moment in the life of the pump. The measurements and calculations provided permit to identify the impact of each part (impeller wear and wear-ring clearance) on the overall pump wear for all pump operating points as in FIG. 3 where curve 16 provides the percentage of performance degradation due to excessive wear-ring clearance, curve 17 shows the percentage of performance degradation due to impeller wear and curve 18 corresponds to the percentage of performance degradation due to both excessive wear-ring clearance and impeller wear.

The present disclosure provides means to identify if there is a fault related to impeller wear or wear-ring clearance separately and to identify the impact of each fault on the pump wear and performances.

Take the advantage of pump efficiency analysis to identify the problems on the mechanical part and their status.

In order to provide the theoretical curves in the program that implements the method of the present disclosure, the pump curves from the manufacturer are entered in such program in a preliminary step as such theoretical pump curves.

An identification of an evolution of the wear ring clearance is done by regularly analyzing the measurements (Power, flow rate) and calculating the wear ring clearance effect using the theoretical pump curves and calculating the mechanical efficiency, hydraulic efficiency, and volumetric efficiency to get the global efficiency at different moments of the life of the pump and to compare later values of such efficiencies with older values with the new status of wear-ring clearance.

The method also provides an identification of the evolution of the impeller wear after deducing the impact of the wear-ring clearance from the theoretical pump curve by analyzing the measurement (Power, Pump head) and the pump curve at flow rate-axis and computing the mechanical efficiency, hydraulic efficiency, and volumetric efficiency to get the global efficiency with the new status of the impeller.

The method may also comprise comparing of an actual flow rate with at least one customer defined flow rate lower limit and providing a warning signal in case of detection of a flow rate lower than said lower limit, a calculation of the impact of the degradation on the efficiency of said impeller and provision of ageing data comprising flow rate reduction and/or head reduction, a calculation of the impact of such degradation on the energy consumption of the pump.

A survey method may comprise also a program to create warning signals upon detection of defined wear-ring clearance and/or impeller wear for providing data for predictive maintenance.

An initialization method may also comprise entering said theoretical Pump mechanical Power versus Flow rate curve 13, said theoretical Head versus Flow rate curve 15 from the pump manufacturer as initial theoretical pump data in a calculation program executing the method of the disclosure.

The invention is not limited to the above description and in example, the program may be embedded in a control unit of the pump connected to sensors on the pump to get the measurement values or embedded in a remote-control center.

1. A method for determining mechanical degradation of parts of a centrifugal pump having a fluid inlet, an impeller and a fluid outlet, comprising:
calculating at least one of a wear-ring clearance effect and an impeller wear effect where:
calculating said wear-ring clearance effect is done through:
measuring an actual pump flow rate Op and actual pump power Pwp,
calculating an internal flow rate of the pump Qp_{Pwp} through projecting said actual pump power Pwp on a theoretical Pump Mechanical power versus Pump Flow rate curve at iso mechanical power,
calculating the mechanical power Pw_{Qp} that should be used if the pump worked as specified in the theoretical curve through projecting said actual pump flow rate on said theoretical Pump Mechanical Power versus Pump Flow rate curve at iso flow rate,
applying the measured flow rate Op on a theoretical Pump Head versus Pump Flow rate curve to obtain a theoretical Head Hpₜₕ,
applying the internal flow rate of the pump Qp_{Pwp} on said theoretical Pump Head versus Pump Flow rate curve to obtain an internal Head Hp_{Pwp},
calculating a difference between said theoretical Head and said internal Head Hpₜₕ−Hp_{Pwp} to obtain the loss of Head due to the wear-ring clearance;
and where:
calculating said impeller wear effect is done through:
measuring an actual input pressure pin, an actual output pressure pout and an actual pump power Pwp,
calculating a theoretical flow rate Qp_{Pwp} corresponding to the measured mechanical power Pwp on a theoretical pump characteristic Pump Power versus Pump Flow rate curve,
projecting such theoretical flow rate QpPwp on a theoretical Pump Head versus Pump Flow rate curve at iso-pump flow rate ΔQ=0 to obtain a theoretical Pump Head HpPwp,
calculating the actual Pump Head Hp from the actual input pressure pᵢₙ, and the actual output pressure pₒᵤₜ and a pumped fluid density,
calculating a difference between said theoretical pump head and said actual pump Head HpPwp−Hp to obtain the loss of head due to the impeller wear.

2. The method according to claim 1 comprising calculating a flow rate inside the pump
$${Q}_{{p}_{pump}} = {Qp}_{Pwp} = Qp + Δ Q ,$$
where ΔQ is the additional flow rate due to the increasing of the wear-ring clearance compared to the initial status of the pump that is provided by the theoretical Pump Head versus Flow rate curve, and considering that at the pump head Hp_{Pwp} corresponding to the measured power and at iso-Pump Head H=Hₜₕ=Hp_{Pwp} the Hydraulic efficiency being equal to 1, setting a hydraulic efficiency at:
$${η}_{HY} = \frac{H}{{H}_{th}} = 1 ,$$
the method comprising:
calculating a mechanical efficiency:
$${η}_{m} = \frac{{P}_{I}}{{P}_{s}} = \frac{ρ \cdot g \cdot {Hp}_{Pwp} ( {Q}_{p} + Δ Q )}{{Pw}_{p}}$$
calculating a volumetric efficiency:
$${η}_{v} = \frac{{Q}_{p}}{( {Q}_{p} + Δ Q )}$$
and calculating the efficiency of the pump with pump wear-ring clearance impact
$${η}_{wearRing} = {η}_{m} \times {η}_{HY} \times {η}_{v} = \frac{ρ \cdot g \cdot {Hp}_{Pwp} \cdot {Q}_{p}}{{Pw}_{p}}$$

3. The method for determining mechanical degradation of parts of a centrifugal pump according to claim 2 comprising calculating a theoretical efficiency:
$${η}_{theoretical} = \frac{ρ \cdot g \cdot {Hp}_{th} \cdot Qp}{{Pw}_{Qp}}$$
and calculating an impact of the Excessive wear-ring clearance on the overall pump as:
$${η}_{WearRingImpact} = \frac{{η}_{wearRing} - {η}_{theoretical}}{{η}_{theoretical}}$$

4. The method according to claim 1 wherein calculating an impeller wear impact comprises at iso-pump flow rate ΔQ=0 calculating a mechanical efficiency:
$${η}_{m} = \frac{{P}_{I}}{{P}_{s}} = \frac{ρ \cdot g \cdot {Hp}_{th} \cdot ( {Q}_{p} + Δ Q )}{{Pw}_{Qp}} = \frac{ρ \cdot g \cdot {Hp}_{th} \cdot Qp}{{Pw}_{Qp}}$$
and calculating the efficiency of the pump with impeller wear impact
$${η}_{impellerWear} = {η}_{m} \times {η}_{HY} \times {η}_{v} = \frac{ρ \cdot g \cdot ( {Hp}_{th} - ( {Hp}_{pwp} - Hp ) ) \cdot Qp}{{Pw}_{Qp}} \\ where \\ {η}_{HY} = \frac{( {Hp}_{th} - ( {Hp}_{pwp} - Hp ) )}{{Hp}_{th}}$$
and
a volumetric efficiency ηᵥ is set to 1.

5. The method for determining mechanical degradation of parts of a centrifugal pump according to claim 4 comprising calculating the impact of the impeller wear on the overall pump wear as:
$${η}_{ImpellerWearImpact} = \frac{{η}_{impellerWear} - {η}_{theoretical}}{{η}_{theoretical}} \\ where \\ {η}_{theoretical} = \frac{ρ \cdot g \cdot {Hp}_{th} \cdot {Q}_{p}}{{Pw}_{Qp}}$$

6. The method for determining mechanical degradation of parts of a centrifugal pump according to claim 1 repeated from time to time to obtain a plurality of measurements of the global efficiency of the pump.

7. The method for determining mechanical degradation of parts of a centrifugal pump according to claim 6 comprising a program designed to detect an evolution of a pump wear-ring clearance evolution through calculating said wear-ring clearance effect through measuring the initial power and flow rate of the pump at a time t0, calculating the initial Head of the pump Hp_{Pwp}, calculating the initial loss of Head (Hpₜₕ−Hp_{Pwp})ₜ₀, measuring from time to time tₙ=tₙ₋₁+Δt with the pump in use the power and flow rate of the pump and calculating the head and loss of Head due to the wear-ring clearance, comparing the obtained wear-ring clearance effect (Hpₜₕ−Hp_{Pwp})ₜₙ at time tₙ with the initial Head loss at time t0 to obtain a wear-ring clearance evolution of the pump.

8. The method for determining mechanical degradation of parts of a centrifugal pump according to claim 6 comprising identifying with said program an evolution of a pump impeller wear evolution through calculating said impeller wear effect through measuring an initial input pressure pᵢₙₜ₀, an actual output pressure pₒᵤₜₜ₀ and an initial pump power Pwpₜ₀ of the pump at a time t0, calculating the initial Head of the pump Hp_{Pwp} at iso-pump flow rate ΔQ=0, calculating the initial loss of Head (Hp_{Pwp}−Hp)ₜ₀, measuring from time to time tₙtₙ₋₁+Δt with the pump in use the input pressure pᵢₙₜₙ, Output pressure pₒᵤₜₜₙ and pump power Pwpₜₙ of the pump and calculating the head and loss of Head due to the impeller wear at iso-pump flow rate ΔQ=0, comparing the obtained impeller wear (Hp_{Pwp}−Hp)ₜₙ with the initial Head loss to obtain a impeller wear evolution of the pump.

9. The method for determining mechanical degradation of parts of a centrifugal pump according to claim 1 wherein said measurements are done in real time during operation of the pump.

10. The method for determining degradation of a centrifugal pump according to claim 1 comprising comparing of an actual flow rate with at least one customer defined flow rate lower limit and providing a warning signal in case of detection of a flow rate lower than said lower limit.

11. The method for determining degradation of a centrifugal pump according to claim 10 comprising calculating the impact of the degradation on the efficiency of said impeller and provision of ageing data comprising flow rate reduction and/or head reduction.

12. The method for determining degradation of a centrifugal pump according to claim 11 comprising calculating the impact of such degradation on the energy consumption of the pump.

13. The method for determining degradation of a centrifugal pump according to claim 1 comprising creating warning signals upon detection of defined wear-ring clearance and/or impeller wear for providing data for predictive maintenance.

14. The method for determining degradation of a centrifugal pump according to claim 1 comprising entering said theoretical Pump mechanical Power versus Flow rate curve, said theoretical Head versus Flow rate curve from the pump manufacturer as initial theoretical pump data in a calculation program.

15. A non-transitory computer-readable recording medium on which a software is stored to implement the method according to claim 1 when the software is executed by a processor.

16. A non-transitory computer-readable recording medium on which computer software is stored, the computer software comprising instructions to implement the method according to claim 2 when the software is executed by a processor.
